(19) United States
(12) Patent Application Publication
(10) Pub. No.: US 2013/0144716 A1
(43) Pub. Date: Jun. 6, 2013

(54) ADVERTISING OPPORTUNITIES FOR LIVE STREAMING CONTENTS AND SERVICES

(71) Applicants: True Xiong, San Diego, CA (US); Leo Pedlow, Ramona, CA (US); Viral Mehta, San Diego, CA (US); Eric Holcomb, San Marcos, CA (US); Kathy Fielder, Oceanside, CA (US)

(72) Inventors: True Xiong, San Diego, CA (US); Leo Pedlow, Ramona, CA (US); Viral Mehta, San Diego, CA (US); Eric Holcomb, San Marcos, CA (US); Kathy Fielder, Oceanside, CA (US)

(73) Assignees: SONY NETWORK ENTERTAINMENT INTERNATIONAL LLC, Los Angeles, CA (US); SONY CORPORATION, Tokyo (JP)

(21) Appl. No.: 13/312,210

(22) Filed: Dec. 6, 2011

(51) Int. Cl. G06Q 30/02

(52) U.S. Cl. 705/14.52

(57) ABSTRACT

Placing advertisement, informational or promotional material into a live stream event streamed to a client device, including: establishing a private relationship between a server and the client device; receiving statistical studies performed of a pattern of behavior of members of the private relationship with respect to contents and services streamed live; preparing and storing the advertisement, informational or promotional material based on the statistical studies; selecting the stored advertisement, informational or promotional material for the client device; and placing the selected advertisement, informational or promotional material into a temporally and spatially appropriate position of the live stream event. Keywords include live media stream and BIVL.

### BACKGROUND

1. Field of the Invention

The present invention relates to live streaming of contents and services, and more specifically, to placing advertisement, informational and/or promotional material to the contents and services being streamed live to client devices.

2. Background

The Internet as a global network for delivery of audio and video content is increasing in popularity which creates both opportunities and challenges to content and service providers. Targeted advertising is one of the opportunities.

### SUMMARY

The present invention provides for placing advertisement, informational or promotional material into a live stream event streamed to a client device.

In one implementation, a method of placing advertisement, informational or promotional material into a live stream event streamed to a client device is disclosed. The method includes: establishing a private relationship between a server and the client device; receiving statistical studies performed of a pattern of behavior of members of the private relationship with respect to contents and services streamed live; preparing and storing the advertisement, informational or promotional material based on the statistical studies; selecting the stored advertisement, informational or promotional material for the client device; and placing the selected advertisement, informational or promotional material into a temporally and spatially appropriate position of the live stream event.

In another implementation, a system for a live stream event streamed to a client device is disclosed. The system includes: a processor configured to establish a private relationship between the system and the client device, and to receive statistical studies performed of a pattern of behavior of members of the private relationship with respect to contents and services streamed live to the client device, the processor operating to prepare and store a plurality of advertisement, informational or promotional materials based on the statistical studies; an advertisement processing unit to select at least one advertisement, informational or promotional material specifically for the client device from the stored plurality of advertisement, informational or promotional materials; and a live streaming unit configured to place the selected at least one advertisement, informational or promotional material into a temporally and spatially appropriate position of the live stream event.

In another implementation, a non-transitory computer storage medium storing a computer program to place advertisement, informational or promotional material into a live stream event streamed to a client device is disclosed. The computer program includes executable instructions that cause a computer to: establish a private relationship between a server and the client device; receive statistical studies performed of a pattern of behavior of members of the private relationship with respect to contents and services streamed live; prepare and store the advertisement, informational or promotional material based on the statistical studies; select the stored advertisement, informational or promotional material for the client device; and place the selected advertisement, informational or promotional material into a temporally and spatially appropriate position of the live stream event.

Other features and advantages of the present invention will become more readily apparent to those of ordinary skill in the art after reviewing the following detailed description and accompanying drawings.

### BRIEF DESCRIPTION OF THE DRAWINGS

FIG. 1 is a functional block diagram of an advertisement processing system residing within a server in accordance with one implementation of the present invention.

FIG. 2 is a flowchart illustrating a process for placing advertisement, informational and/or promotional material into the contents and services streamed live to the client device in accordance with one implementation of the present invention.

FIG. 3A illustrates a representation of a computer system and a user.

FIG. 3B is a functional block diagram illustrating the computer system hosting an advertisement processor.

### DETAILED DESCRIPTION

Contents and services involving concerts, sporting events, movies, conferences, or other similar events can be streamed live to client devices. Moreover, the contents and services can be streamed live over a communications protocol such as the Internet Protocol (IP), which is currently a primary protocol that delivers data packets from a source host (e.g., a server) to the client devices based on their addresses. It should be noted that although the Internet Protocol is mentioned as the communications protocol, other future protocols can also be used in the future.

Certain implementations as described herein provide for placing advertisement, informational and/or promotional material to the contents and services being streamed live to the client devices. The type of advertisement, informational and/or promotional material for contents and services being streamed live to the client devices can be based on several factors. The factors can include the phase of the live stream event (e.g., the half time of a sporting event), the physical location of the client device (e.g., indicated by its IP address), the timing of the client device's entry into the stream (e.g., just when the batter in a baseball game hits a homerun), the capabilities of the client device (e.g., that the client device is a 3-D capable device), and other personal information of the user of the client device known to the source host (e.g., that the user is a student who likes college football).

Other factors can include content category, title, and types. The personal information of the user of the client device can also include a buying history of the user of the client device, which can be used by advertisers to place targeted advertisements that would be of most interest and have the highest chance of being bought by the user. The advertisement can be tailored for each product category for a single user account or profile. Other personal information can include a language preference of the user. For example, users watching English football game (i.e., soccer) in Spanish should get targeted advertisement in Spanish rather than in English.

After reading this description it will become apparent how to implement the invention in various implementations and applications. Although various implementations of the present invention will be described herein, it is understood that these implementations are presented by way of example only, and not limitation. As such, this detailed description of various implementations should not be construed to limit the scope or breadth of the present invention.

The implementation of the above factors in incorporating the advertisement, informational and/or promotional material into the contents and services being streamed live can be facilitated by configuring the live streaming system within the infrastructure of an existing private relationship such as a server-client relationship. The existing private relationship between a client device and a source host such as a server provides the ability for the client device to authenticate itself using a valid certificate over a secure protocol. Thus, once the client device is authenticated by the server, the client device is able to access the live streaming contents and services.

Further, if an existing private relationship has been established between the client device and the server, subsequent visits by the client device to the server to get streaming packets will reveal information about the client device and the user based on the existing relationship. Accordingly, the server is able to serve the client device with substantial information about the client device and its user. For example, because of the established server-client relationship, the server can have substantial information about the physical location of the client device, the capabilities of the client device, and other personal information of the user of the client device.

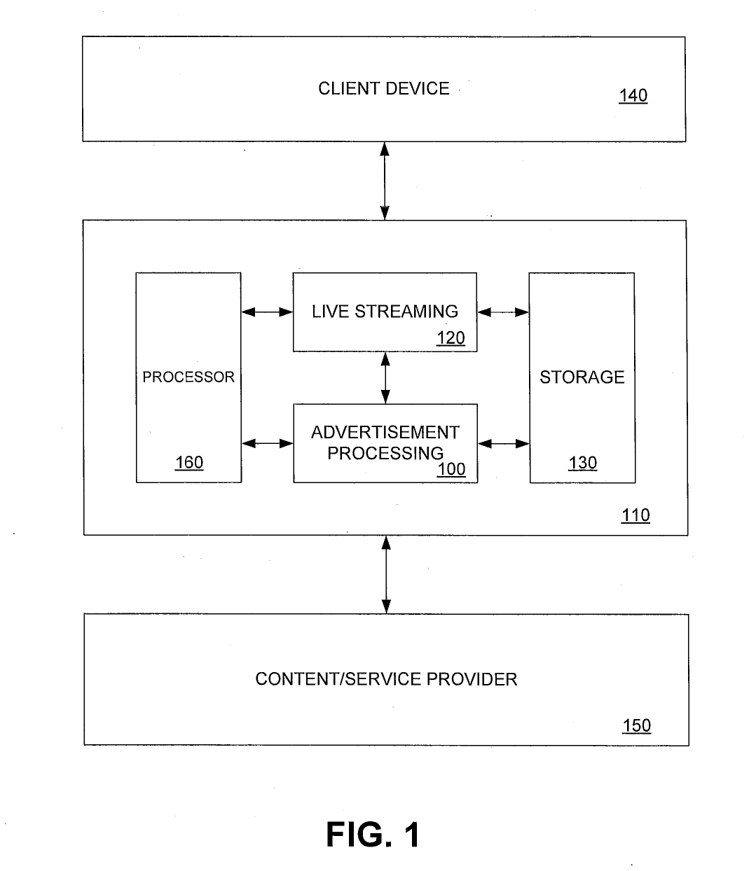

FIG. 1 is a functional block diagram of an advertisement processing system 100 residing within a server 110 in accordance with one implementation of the present invention. In the illustrated implementation of FIG. 1, the server 110, which is in communication with a client device 140 and a content and service provider 150, also includes a processor 160, a live streaming unit 120 and storage 130. In one example, the server 110 can be configured as a Bravia Internet Video Link (BIVL) system which provides video streaming and on-demand services accessible through a client device (e.g., home appliances such as a television). The client device 140 can be configured as an Internet Protocol Television (IPTV) unit. Further, the content/service provider 150 can be configured as an entity that is capturing the live event on site and transmitting it over to the client device 140 through the server 110.

The live streaming unit 120 streams live contents and services involving concerts, sporting events, movies, conferences, or other similar events received from the content/service provider 150 over to the client device 140. The contents and services can be streamed live over the Internet Protocol (IP) to deliver data packets from the server 110 to the client device 140. The advertisement processing unit 100 is configured to provide for placing advertisement, informational and/or promotional material to the live streaming contents and services based on several factors related to the client device 140.

In one implementation, the advertisement processing unit 100 selects and inserts the type of advertisement, informational and/or promotional material to be placed into the contents and services streamed live to the client device 140. The type of advertisement, informational and/or promotional material placed into the live contents and services is based on factors including the phase of the live stream event, the physical location of the client device, the entry time of the client device into the stream, the capabilities of the client device, and other personal information of the user of the client device known to the source host. In one example, depending on the physical location of the client device 140, a selector (not shown) in the advertisement processing unit 100 selects and inserts the advertisement, informational and/or promotional material to cover the local area of the physical location. In another example, if it is known to the server 110 that the client device 140 is capable of displaying 3-D images, the selector selects appropriate 3-D advertisement, informational and/or promotional material from the storage 130 and places it into a temporally and spatially appropriate place of the live contents and services being streamed to the client device 140. In yet another example, if it is known to the server 110 that the user of the client device 140 is a person who likes college football, the advertisement processing unit 100 can retrieve an advertisement, informational and/or promotional material promoting college football and place it into a temporally and spatially appropriate place of the live contents and services being streamed to the client device 140.

In the illustrated implementation of FIG. 1, the live streaming unit 120 is configured within the infrastructure of an existing private relationship between the server 110 and the client device 140. Since the existing private relationship provides the ability for the server 110 to collect and store various information related to the client device 140, the above-mentioned factors which determine the type of advertisement, informational and/or promotional material placed into the contents and services streamed live to the client device 140 can be readily ascertained. For example, if an existing private relationship has been established between the client device 140 and the server 110, subsequent visits by the client device to the server to get streaming packets will reveal information about the client device and the user, which will be used by the advertisement processing unit 100 to retrieve appropriate advertisement, informational and/or promotional material and place it into a temporally and spatially appropriate place of the live contents and services being streamed to the client device 140.

In one implementation, a plurality of advertisement, informational and/or promotional materials is prepared by the processor 160, and categorized and stored in the storage 130 prior to the scheduled start time of the live event. The categorization can be based on prior statistical studies of the pattern of behavior of the members (or the capabilities of the client devices) of the private relationship with respect to the live streaming service. For example, if it was determined from prior statistical studies that the majority of the members subscribing to live pro football games are men, most of the prepared advertisement, informational and/or promotional material would be geared toward men. For another example, if it was determined that some members have client devices that are 3-D capable, some ad material would be prepared in 3-D and only those with the 3-D capable client device would be sent the 3-D material.

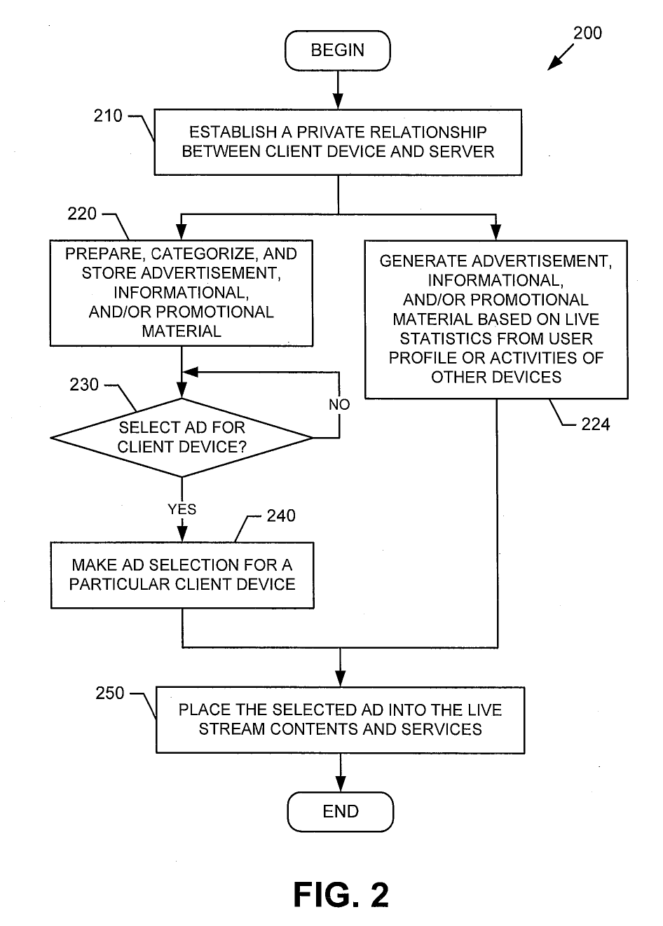

FIG. 2 is a flowchart illustrating a process 200 for placing advertisement, informational and/or promotional material into the contents and services streamed live to the client device in accordance with one implementation of the present invention. In the illustrated implementation of FIG. 2, once a private relationship between a server and a client is established, at box 210, advertisement, informational and/or promotional material is prepared and stored, at box 220, based on prior statistical studies of the pattern of behavior of the members (or the capabilities of the client devices) of the private relationship with respect to a live streaming service. In one implementation, the prepared statistical studies of the pattern of behavior of the members can be categorized before being stored. In another implementation, the statistical studies of the pattern of behavior of the members can be received from a separate entity rather than actually performing the studies. In a further implementation, the prepared advertisement, informational and/or promotional material can change based on live statistics from the user profile or activities of other devices (see box 224). For instance, a household has four devices tied to one account or profile. While the husband is watching a football game on a first client device (e.g., an Internet Protocol TV), the wife turns on a second client device (e.g., a tablet device) and searches for Thanksgiving coupons. Such search information and meta-data generated by the wife's searching will be updated in real-time. Accordingly, Thanksgiving sales promotions and advertisements can be delivered to the first client device that is live streaming the football game. Accordingly, it should be noted that targeted advertisement, informational and/or promotional material can be delivered and changed before, during, and after a play of a live streaming content.

When a request is received to select advertisement, informational and/or promotional material, at box 230, a selection is made, at box 240, for a particular client device. At box 250, the selected advertisement, informational and/or promotional material is placed into the live stream contents and services to the particular client device. In a case where the prepared advertisement, informational and/or promotional material is changed, the request (at box 230) and the selection (at box 240) may occur automatically (or not occur at all) so that the search information and meta-data generated by live statistics from the user profile or activities of other devices are placed into the live stream contents and services (at box 250). Again, the selection (if it occurs) is based on factors including the phase of the live stream event, the physical location of the client device, the entry time of the client device into the stream, the capabilities of the client device, and other personal information of the user of the client device known to the server. For example, if it was determined from the prior statistical studies that women members primarily join live pro football games after the half time, the advertisement, informational and/or promotional material geared toward women would be placed into the stream after the half time of the football games.

Regarding the placement of the selected advertisement, informational and/or promotional material into the live stream contents and services to a particular client device, it should be noted that the material is placed into a temporally and spatially appropriate position of the live contents and services. For example, one temporally and spatially appropriate place would at the beginning of the live event after the entry of the client device into the stream (e.g., when the client device requests a first series of packets from the live stream) but before the scheduled start time of the live event.

In one implementation, the advertisement, informational and/or promotional material to be placed into the live stream at the beginning or during the event can take the form of video, image, web beacon, and other similar forms. The advertisement, informational and/or promotional material to be placed into the live stream at the end of the event can be presented by playing video, displaying image, sending web beacon, launching a web browser, sharing the content with social networks, etc.

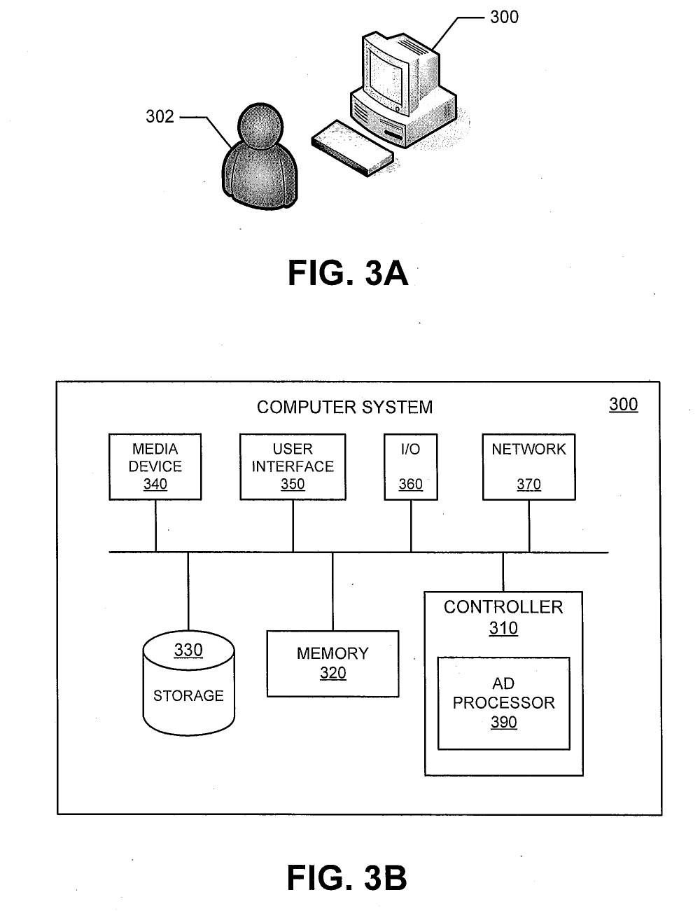

FIG. 3A illustrates a representation of a computer system 300 and a user 302. The user 302 uses the computer system 300 to process advertisement. The computer system 300 stores and executes an advertisement processor 390.

FIG. 3B is a functional block diagram illustrating the computer system 300 hosting the advertisement processor 390. The controller 310 is a programmable processor and controls the operation of the computer system 300 and its components. The controller 310 loads instructions (e.g., in the form of a computer program) from the memory 320 or an embedded controller memory (not shown) and executes these instructions to control the system. In its execution, the controller 310 provides the advertisement processor 390 as a software system. Alternatively, this service can be implemented as separate hardware components in the controller 310 or the computer system 300.

Memory 320 stores data temporarily for use by the other components of the computer system 300. In one implementation, memory 320 is implemented as RAM. In one implementation, memory 320 also includes long-term or permanent memory, such as flash memory and/or ROM.

Storage 330 stores data temporarily or long term for use by other components of the computer system 300, such as for storing data used by the advertisement processor 390. In one implementation, storage 330 is a hard disk drive.

The media device 340 receives removable media and reads and/or writes data to the inserted media. In one implementation, for example, the media device 340 is an optical disc drive.

The user interface 350 includes components for accepting user input from the user of the computer system 300 and presenting information to the user. In one implementation, the user interface 350 includes a keyboard, a mouse, audio speakers, and a display. The controller 310 uses input from the user to adjust the operation of the computer system 300.

The I/O interface 360 includes one or more I/O ports to connect to corresponding I/O devices, such as external storage or supplemental devices (e.g., a printer or a PDA). In one implementation, the ports of the I/O interface 360 include ports such as: USB ports, PCMCIA ports, serial ports, and/or parallel ports. In another implementation, the I/O interface 360 includes a wireless interface for communication with external devices wirelessly.

The network interface 370 includes a wired and/or wireless network connection, such as an RJ-45 or “Wi-Fi” interface (including, but not limited to 302.11) supporting an Ethernet connection.

The computer system 300 includes additional hardware and software typical of computer systems (e.g., power, cooling, operating system), though these components are not specifically shown in FIG. 3B for simplicity. In other implementations, different configurations of the computer system can be used (e.g., different bus or storage configurations or a multi-processor configuration).

The above description of the disclosed implementations is provided to enable any person skilled in the art to make or use the invention. Various modifications to these implementations will be readily apparent to those skilled in the art, and the generic principles described herein can be applied to other implementations without departing from the spirit or scope of the invention. Accordingly, additional implementations and variations are also within the scope of the invention. For example, the implementations discussed above focus on live streaming contents and services, but the advertisement placement of contents and services that are not live and/or non-streaming can also be performed. Further, it is to be understood that the description and drawings presented herein are representative of the subject matter which is broadly contemplated by the present invention. It is further understood that the scope of the present invention fully encompasses other implementations that may become obvious to those skilled in the art and that the scope of the present invention is accordingly limited by nothing other than the appended claims.

1. A method of placing advertisement, informational or promotional material into a live stream event streamed to a client device, the method comprising:
establishing a private relationship between a server and the client device;
receiving statistical studies performed of a pattern of behavior of members of the private relationship with respect to contents and services streamed live;
preparing and storing the advertisement, informational or promotional material based on the statistical studies;
selecting the stored advertisement, informational or promotional material for the client device; and
placing the selected advertisement, informational or promotional material into a temporally and spatially appropriate position of the live stream event.

2. The method of claim 1, wherein selecting the advertisement, informational or promotional material is based on a physical location of the client device.

3. The method of claim 1, wherein selecting the advertisement, informational or promotional material is based on an entry time of the client device into the live stream event.

4. The method of claim 1, wherein selecting the advertisement, informational or promotional material is based on a phase of the live stream event at an entry time of the client device into the live stream event.

5. The method of claim 1, wherein selecting the advertisement, informational or promotional material is based on capabilities of the client device.

6. The method of claim 1, wherein selecting the advertisement, informational or promotional material is based on personal information of a user of the client device known to the server.

7. The method of claim 1, wherein selecting the advertisement, informational or promotional material is based on at least one of:
a physical location of the client device;
an entry time of the client device into the live stream event;
a phase of the live stream event at the entry time;
capabilities of the client device; and
personal information of a user of the client device known to the server.

8. The method of claim 1, wherein the temporally and spatially appropriate position of the live stream event comprises
a beginning of the live stream event after an entry time of the client device into the live stream event but before a scheduled start time of the live stream event.

9. A system for a live stream event streamed to a client device, the system comprising:
a processor configured to establish a private relationship between the system and the client device, and to receive statistical studies performed of a pattern of behavior of members of the private relationship with respect to contents and services streamed live to the client device, the processor operating to prepare and store a plurality of advertisement, informational or promotional materials based on the statistical studies;
an advertisement processing unit to select at least one advertisement, informational or promotional material specifically for the client device from the stored plurality of advertisement, informational or promotional materials; and
a live streaming unit configured to place the selected at least one advertisement, informational or promotional material into a temporally and spatially appropriate position of the live stream event.

10. The system of claim 9, wherein the live stream event is one of a concert, a sporting event, a movie, and a conference.

11. The system of claim 9, wherein the private relationship between the system and the client device provides the ability for the processor to collect and store information related to the client device.

12. The system of claim 9, further comprising
a storage unit configured to categorize and store the plurality of advertisement, informational or promotional materials prepared by and received from the processor.

13. The system of claim 9, wherein the processor further comprises
a selector configured to select the at least one advertisement, informational or promotional material specifically for the client device based on at least one of:
a physical location of the client device;
an entry time of the client device into the live stream event;
a phase of the live stream event at the entry time;
capabilities of the client device; and
personal information of a user of the client device known to the system.

14. A non-transitory computer storage medium storing a computer program to place advertisement, informational or promotional material into a live stream event streamed to a client device, the computer program comprising executable instructions that cause a computer to:
establish a private relationship between a server and the client device;
receive statistical studies performed of a pattern of behavior of members of the private relationship with respect to contents and services streamed live;
prepare and store the advertisement, informational or promotional material based on the statistical studies;
select the stored advertisement, informational or promotional material for the client device; and
place the selected advertisement, informational or promotional material into a temporally and spatially appropriate position of the live stream event.

15. The non-transitory computer storage medium of claim 14, wherein the computer program comprising executable instructions that cause a computer to select the advertisement, informational or promotional material based on at least one of:
a physical location of the client device;
an entry time of the client device into the live stream event;
a phase of the live stream event at the entry time;
capabilities of the client device; and
personal information of a user of the client device known to the server.
